(19) United States
(12) Patent Application Publication
(10) Pub. No.: US 2009/0307089 A1
(43) Pub. Date: Dec. 10, 2009

(54) METHOD AND SYSTEM FOR SHARING ADVERTISEMENTS IN A CHAT ENVIRONMENT

(75) Inventor: ANDREAS BINNEWIES, Berkeley, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Meebo Inc.

(21) Appl. No.: 12/480,643

(22) Filed: Jun. 8, 2009

Related U.S. Application Data
(60) Provisional application No. 61/059,697, filed on Jun. 6, 2008.

(51) Int. Cl. G06Q 30/00; G06F 15/16

(52) U.S. Cl. 705/14.55; 705/14.69; 709/203; 709/206

(57) ABSTRACT

A method and system for sharing advertisements in a chat environment are disclosed. According to one embodiment a computer-implemented method comprises receiving a first request for an advertisement from a first client, providing a first advertisement to the first client, the first client submitting a second request to transmit a reference to the first advertisement to a second client. A third request is received for the first advertisement from the second client and the first advertisement is provided to the second client.

The present application claims the benefit of and priority to U.S. Provisional Patent Application No. 61/059,697 entitled “Sharing Advertisements in a Chat Environment” filed on Jun. 6, 2008, and is hereby, incorporated by reference.

### FIELD

The present invention relates generally to the field of computer applications and, more specifically, to sharing advertisements in a chat environment.

### BACKGROUND

In existing advertising systems, a page requests an advertisement (ad) from an ad server and the server returns an ad from a selection of many ads. The sharing of specific ads in existing systems involves a first user visiting a website. The website requests an ad from the ad server. The ad server returns a random ad, and the first user ‘shares’ the ad with a second user. The advertisement sends the second user a message that contains a URL pointing to the landing page for the ad. When the second user clicks on the link, she sees a different ad than what the first user saw and intended to share with her. The limitation is that the first and second users do not have the same ad experience.

### SUMMARY

A method and system for sharing advertisements in a chat environment are disclosed. According to one embodiment a computer-implemented method comprises receiving a first request for an advertisement from a first client, providing a first advertisement to the first client, the first client submitting a second request to transmit a reference to the first advertisement to a second client. A third request is received for the first advertisement from the second client and the first advertisement is provided to the second client.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1 illustrates an exemplary computer architecture for use with the present system, according to one embodiment.

FIG. 2 illustrates sharing of an advertisement between two users, according to one embodiment.

FIG. 3 illustrates a flow diagram for an advertisement sharing process, according to one embodiment.

FIG. 4A illustrates a flow diagram for encoding an advertisement ID, according to one embodiment.

FIG. 4B illustrates a flow diagram for decoding a URL containing an advertisement ID, according to one embodiment.

FIG. 5 illustrates a system level diagram of an advertisement sharing system, according to one embodiment.

### DETAILED DESCRIPTION

A method and system for sharing advertisements in a chat environment are disclosed. According to one embodiment a computer-implemented method comprises receiving a first request for an advertisement from a first client, providing a first advertisement to the first client, the first client submitting a second request to transmit a reference to the first advertisement to a second client. A third request is received for the first advertisement from the second client and the first advertisement is provided to the second client.

Advertising servers provide a way of requesting a specific ad from their category of advertisements (ads). For example, DoubleClick uses key/value pairs and Atlas uses unique IDs. The present system utilizes these existing mechanisms to allow a first user and a second user to see the exact same ad.

According to one embodiment, a first user visits a website hosted by a system. The system requests an ad from an ad server. The ad server returns an ad that contains an id that is unique to the ad. Every ad is given a unique ID when placed on the ad server. Therefore, the ad contains the unique ID when it is returned to the system. The first user clicks ‘Share’ and shares the ad with a second user. The advertisement sends the second user a message with a URL that contains the unique ID. The system extracts the unique id from the advertisement, and sends it to the second user via a URL of the system. The URL points to a landing page of the system that is able to load advertisements by ID.

The second user clicks on the link and lands on a system hosted page. The system requests the ad with the specified ID from the ad server. The system appends the unique ID to the ad tag request. The ad server matches this unique ID with the ads in its database, and returns the ad matching the ID (which is the same one it returned to the first user). Therefore the second user sees the same ad as what the first user viewed and intended to share.

The system displays the advertisement for the second user as soon as it is retrieved from the ad server. According to one embodiment, the system may calculate a charge for each sharing of the advertisement.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. A method is here, and generally, conceived to be a self-consistent process leading to a desired result. The process involves physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present method and system also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

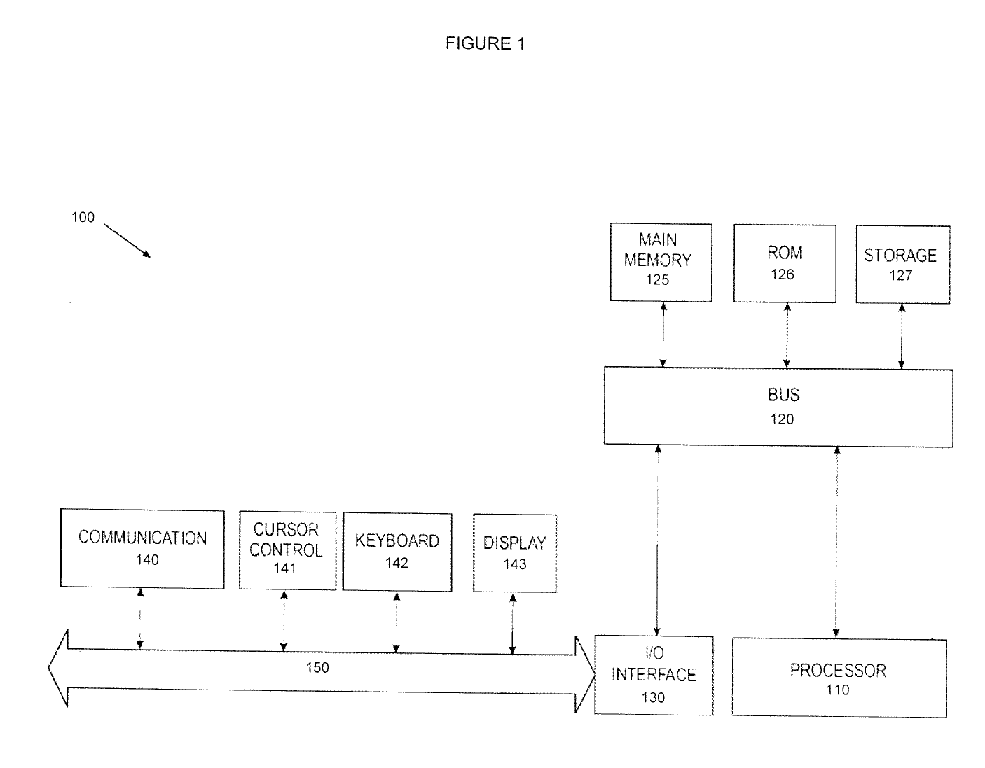

FIG. 1 illustrates an exemplary computer architecture for use with the present system, according to one embodiment. One embodiment of architecture 100 comprises a system bus 120 for communicating information, and a processor 110 coupled to bus 120 for processing information. Architecture 100 further comprises a random access memory (RAM) or other dynamic storage device 125 (referred to herein as main memory), coupled to bus 120 for storing information and instructions to be executed by processor 110. Main memory 125 also may be used for storing temporary variables or other intermediate information during execution of instructions by processor 110. Architecture 100 also may include a read only memory (ROM) and/or other static storage device 126 coupled to bus 120 for storing static information and instructions used by processor 110.

A data storage device 127 such as a magnetic disk or optical disc and its corresponding drive may also be coupled to computer system 100 for storing information and instructions. Architecture 100 can also be coupled to a second I/O bus 150 via an I/O interface 130. A plurality of I/O devices may be coupled to I/O bus 150, including a display device 143, an input device (e.g., an alphanumeric input device 142 and/or a cursor control device 141).

The communication device 140 allows for access to other computers (servers or clients) via a network. The communication device 140 may comprise one or more modems, network interface cards, wireless network interfaces or other well known interface devices, such as those used for coupling to Ethernet, token ring, or other types of networks.

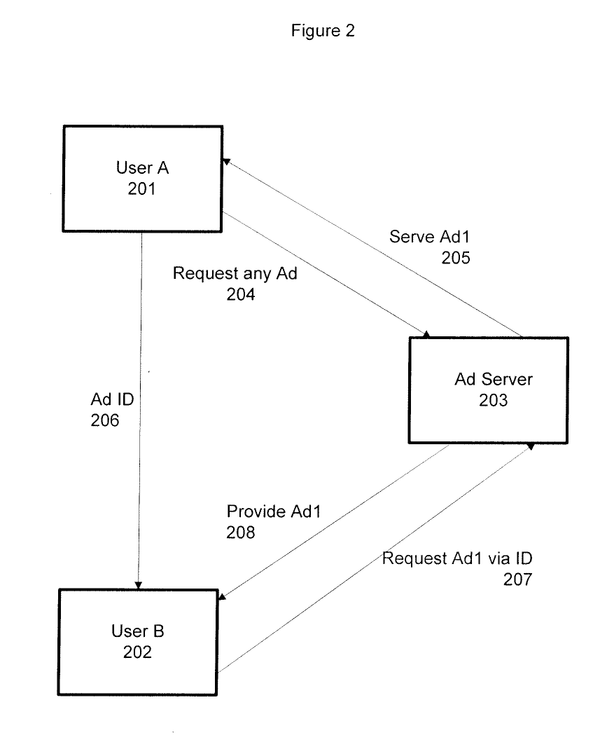

FIG. 2 illustrates sharing of an advertisement between two clients, according to one embodiment. User A 201 requests any advertisement (ad) 204 from an ad server 203. The ad server 203 serves an ad Ad1 205. User A 201 elects to share Ad1 with User B 202 and the Ad ID 206 associated with Ad1 is transmitted to User B 202. User B 202 requests Ad1 via the ID 207 provided, from the ad server 203. The ad server 203 provides Ad1 208 to User B 202.

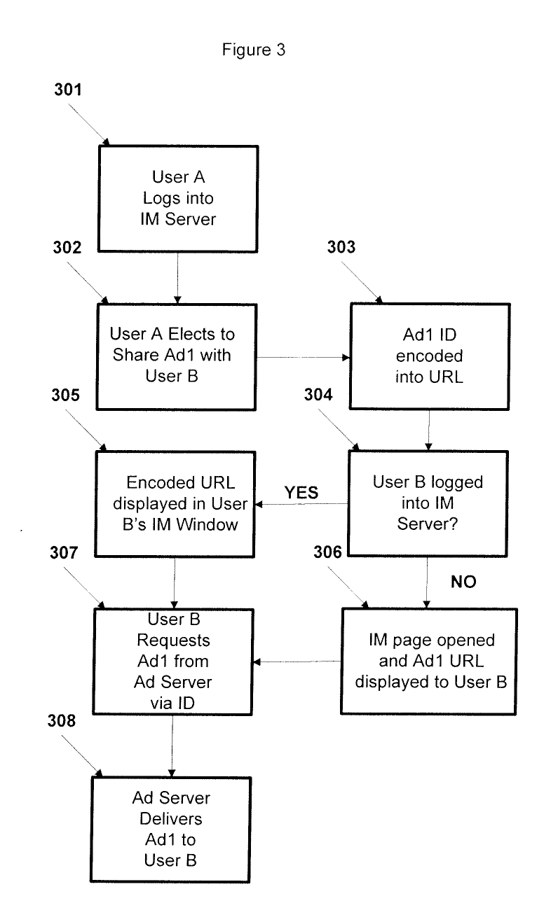

FIG. 3 illustrates the flow of an advertisement sharing process, according to one embodiment. User A logs into an instant messaging (IM) server 301, elects to share Ad1 with User B 302, and the Ad1 ID is encoded into a URL 303. If User B is logged into the IM server 304 the encoded URL is displayed to User B in User B's IM window 305. If User B is not logged into the IM server 304 then an IM page is opened and the Ad1 URL is displayed to User B 306.

User B then requests Ad1 from the ad server by clicking on the URL and subsequently transmitting the Ad1 ID to the ad server 307. The ad server delivers Ad1 to User B 308.

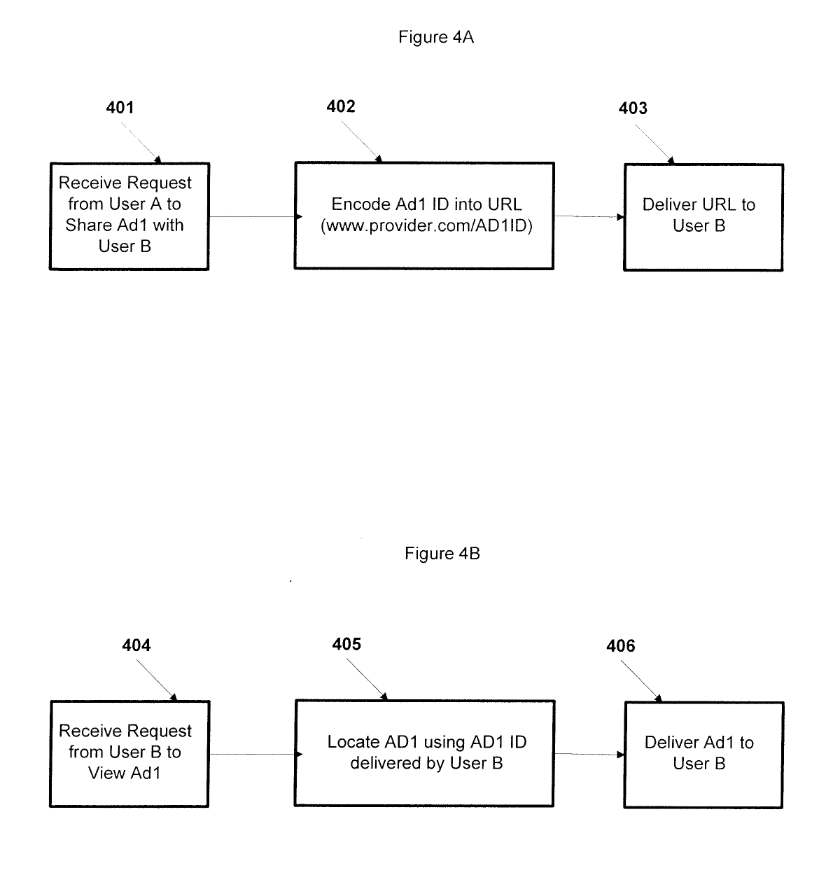

FIG. 4A illustrates a flow diagram for encoding an advertisement ID, according to one embodiment. A request is received from User A to share Ad1 with User B 401. Ad1 ID is encoded into a URL 402. The URL with the Ad1 ID encoded in it is delivered to User B 403.

FIG. 4B illustrates a flow diagram for decoding a URL containing an advertisement ID, according to one embodiment. A request is received from User B to view Ad1 404. Using the Ad1 ID delivered by User B, Ad1 is located 405. Ad1 is delivered to User B 406.

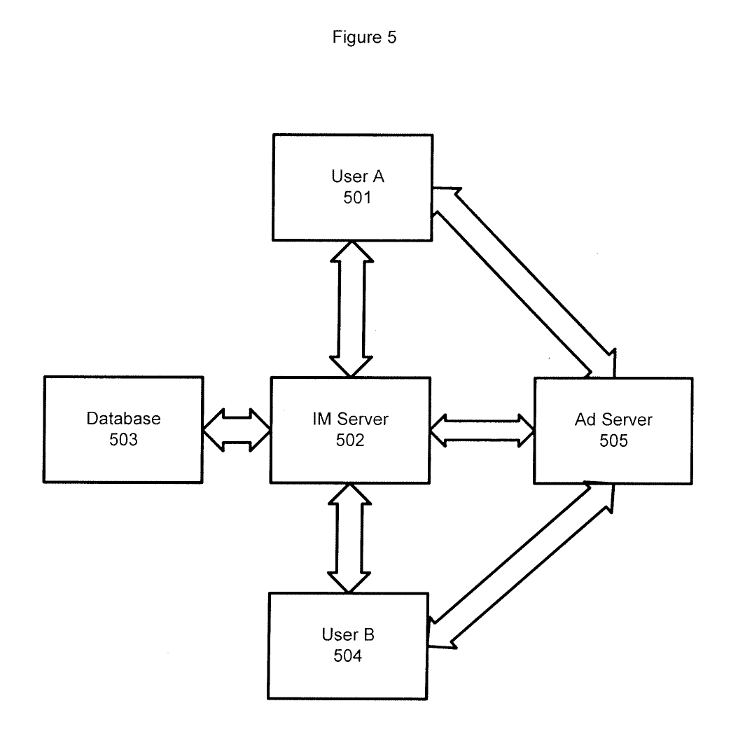

FIG. 5 illustrates a system level diagram of an advertisement sharing system, according to one embodiment. An IM server 502 is in communication with a database 503 and multiple users, for example here User A 501 and User B 504. The IM server 502 is in communication with an ad server 505. User A 501 and User B 504 are also in communication with the ad server 505. An IM server 502 provides instant messaging capability, while an ad server 505 provides advertisements. Users A and B, 501 and 504 can be using any appropriate type of client system. The database 503 stores user information, according to one embodiment. According to one embodiment, the IM server 502 can be a provider server and an IM server 502. A provider server manages and provides access to user information stored in the database 503.

A method and system for sharing advertisements in a chat environment are disclosed. It is understood that the embodiments described herein are for the purpose of elucidation and should not be considered limiting the subject matter of the present embodiments. Various modifications, uses, substitutions, recombinations, improvements, methods of productions without departing from the scope or spirit of the present invention would be evident to a person skilled in the art.

I claim:

1. A computer-implemented method, comprising:
receiving a first request for an advertisement from a first client;
providing a first advertisement to the first client, the first client submitting a second request to transmit a reference to the first advertisement to a second client;
receiving a third request for the first advertisement from the second client; and
providing the first advertisement to the second client.

2. The computer-implemented method of claim 1, wherein the reference to the first advertisement comprises a unique advertisement identifier and a URL.

3. The computer-implemented method of claim 1, wherein the first client pays a fee to transmit the reference to the first advertisement.

4. A system, comprising:
a first client system in communication with an instant messaging server;
a second client system in communication with the instant messaging server; and
an advertisement server, wherein the advertisement server:
receives a first request for an advertisement from the first client;
provides a first advertisement to the first client, the first client submitting a second request to transmit a reference to the first advertisement to a second client;
receives a third request for the first advertisement from the second client; and
provides the first advertisement to the second client.

5. The system of claim 4, wherein the reference to the first advertisement comprises a unique advertisement identifier and a URL.

6. The system of claim 4, wherein the first client pays a fee to transmit the reference to the first advertisement.

7. A computer-implemented method, comprising:
providing instant messaging access to a first client;
receiving a request from the first client to transmit a reference to an advertisement to a second client;
encoding the reference to the advertisement; and
providing the encoded reference to the advertisement to the second client in an instant messaging interface, wherein the second client views the advertisement by selecting the encoded reference.

8. The computer-implemented method of claim 7, wherein the reference to the advertisement comprises a unique advertisement identifier and a URL.

9. The computer-implemented method of claim 7, wherein the first client pays a fee to transmit the reference to the advertisement.

10. A computer-implemented method, comprising:
accessing an instant messaging application;
receiving and viewing an advertisement;
submitting a request to transmit the advertisement to a client, wherein a reference to the advertisement is provided to the client in an instant messaging interface.

11. The computer-implemented method of claim 10, wherein the reference to the advertisement comprises a unique advertisement identifier and a URL.

12. A system, comprising:
a first client system in communication with an instant messaging server;
a second client system in communication with the instant messaging server; and
an advertisement server in communication with the instant messaging server, wherein the instant messaging server:
provides instant messaging access to the first client;
receives a request from the first client to transmit a reference to an advertisement to the second client;
encodes the reference to the advertisement; and
provides the encoded reference to the advertisement to the second client in an instant messaging interface, wherein the second client views the advertisement by selecting the encoded reference.

13. The system of claim 12, wherein the reference to the advertisement comprises a unique advertisement identifier and a URL.

14. The system of claim 12, wherein the first client pays a fee to transmit the reference to the advertisement.

15. A system, comprising:
a first client system in communication with an instant messaging server;
a second client system in communication with the instant messaging server; and
an advertisement server in communication with the instant messaging server, wherein the first client system:
accesses an instant messaging application;
receives and views an advertisement;
submits a request to transmit the advertisement to the second client system, wherein a reference to the advertisement is provided to the second client system in an instant messaging interface.

16. The system of claim 15, wherein the reference to the advertisement comprises a unique advertisement identifier and a URL.

17. The system of claim 15, wherein the first client pays a fee to transmit the reference to the advertisement.
